(19) United States
(12) Patent Application Publication
(10) Pub. No.: US 2021/0012127 A1
(43) Pub. Date: Jan. 14, 2021

(54) ACTION RECOGNITION METHOD AND APPARATUS, DRIVING ACTION ANALYSIS METHOD AND APPARATUS, AND STORAGE MEDIUM

(71) Applicant: BEIJING SENSETIME TECHNOLOGY DEVELOPMENT CO., LTD., Beijing (CN)

(72) Inventors: Yanjie Chen, Beijing (CN); Fei Wang, Beijing (CN); Chen Qian, Beijing (CN)

(21) Appl. No.: 17/026,933

(22) Filed: Sep. 21, 2020

Related U.S. Application Data
(63) Continuation of application No. PCT/CN2019/108167, filed on Sep. 26, 2019.

(30) Foreign Application Priority Data
Sep. 27, 2018 (CN) 201811130798.6

(51) Int. Cl. G06K 9/00; H04N 5/225; G06K 9/62; G06K 9/32; G06N 3/08; B60W 40/08; B60W 50/14

(52) U.S. Cl. CPC G06K 9/00845; H04N 5/2253; G06K 9/00281; G06K 9/00335; G06K 9/6267; G06K 9/3233; B60W 2540/229; G06K 9/6232; G06K 9/00718; G06N 3/08; B60W 40/08; B60W 50/14; B60W 2420/42; G06K 9/6256

(57) ABSTRACT

An action recognition method and apparatus, a driving action analysis method and apparatus, and a storage medium are provided. The method includes: extracting a feature in an image including a human face; determining, on the basis of the feature, a plurality of candidate boxes including a predetermined action; determining an action target box on the basis of the plurality of candidate boxes, where the action target box includes a face local region and an action interactive object; and categorizing the predetermined action on the basis of the action target box to obtain an action recognition result.

### CROSS REFERENCE TO RELATED APPLICATIONS

The present application is a continuation of International Patent Application No. PCT/CN2019/108167, filed on Sep. 26, 2019, which claims priority to Chinese Patent Application No. 201811130798.6, filed on Sep. 27, 2018. The disclosures of International Patent Application No. PCT/CN2019/108167 and Chinese Patent Application No. 201811130798.6 are hereby incorporated by reference in their entireties.

### BACKGROUND

In recent years, action recognition technology has become a very popular application research field and is shown in many fields and products. The use of the action recognition technology is also the development trend of human-machine interaction in the future, and particularly has a wide application prospect in the driver monitoring field.

### SUMMARY

The present disclosure relates to the technical field of image processing, and in particular to an action recognition method and apparatus, a driving action analysis method and apparatus, and an electronic device.

Embodiments of the present disclosure provide a technical solution for action recognition and a technical solution for driving action analysis.

In a first aspect, the embodiments of the present disclosure provide an action recognition method, including: extracting a feature in an image including a human face; determining, on the basis of the feature, a plurality of candidate boxes including a predetermined action; determining an action target box on the basis of the plurality of candidate boxes, where the action target box includes a face local region and an action interactive object; and categorizing the predetermined action on the basis of the action target box to obtain an action recognition result.

In a second aspect, the embodiments of the present disclosure provide a driving action analysis method, including: acquiring, by a vehicle-mounted camera, a video stream including a face image of a driver; obtaining an action recognition result of at least one image frame in the video stream by any implementation of the action recognition method according to the embodiments of the present disclosure; and generating dangerous driving prompt information in response to the action recognition result satisfying a predetermined condition.

In a third aspect, the embodiments of the present disclosure provide an action recognition apparatus, including: a first extracting unit, configured to extract a feature in an image including a human face; a second extracting unit, configured to determine, on the basis of the feature, a plurality of candidate boxes including a predetermined action; a determining unit, configured to determine an action target box on the basis of the plurality of candidate boxes, where the action target box includes a face local region and an action interactive object; and a categorizing unit, configured to categorize the predetermined action on the basis of the action target box to obtain an action recognition result.

In a fourth aspect, the embodiments of the present disclosure provide a driving action analysis apparatus, including: a vehicle-mounted camera, configured to acquire a video stream including a face image of a driver; an obtaining unit, configured to obtain an action recognition result of at least one image frame in the video stream by any implementation of the action recognition apparatus according to the embodiments of the present disclosure; and a generating unit, configured to generate dangerous driving prompt information in response to the action recognition result satisfying a predetermined condition.

In a fifth aspect, the embodiments of the present disclosure provide an electronic device, including a memory and a processor, where the memory stores computer executable instructions thereon, and when the processor executes the computer executable instructions on the memory, the method according to the first aspect or the second aspect of the embodiments of the present disclosure is implemented.

In a sixth aspect, the embodiments of the present disclosure provide a computer-readable storage medium, where the computer-readable storage medium stores instructions, and when the instructions are run on a computer, the method according to the first aspect or the second aspect of the embodiments of the present disclosure is implemented.

In a seventh aspect, the embodiments of the present disclosure provide a computer program, including computer instructions, where when the computer instructions are run in a processor of a device, the method according to the first aspect or the second aspect of the embodiments of the present disclosure is implemented.

### BRIEF DESCRIPTION OF THE DRAWINGS

To describe the technical solutions in embodiments of the present disclosure or the background art more clearly, the accompanying drawings required for describing the embodiments of the present disclosure or the background art are described below.

FIG. 1 is a schematic flowchart of an action recognition method provided in embodiments of the present disclosure.

FIG. 2 is a schematic diagram of a target action box provided in embodiments of the present disclosure.

FIG. 3 is a schematic flowchart of another action recognition method provided in embodiments of the present disclosure.

FIG. 4 is a schematic diagram of a negative sample image including an action similar to a predetermined action provided in embodiments of the present disclosure.

FIG. 5 is a schematic flowchart of a driving action analysis method provided in embodiments of the present disclosure.

FIG. 6 is a schematic flowchart of a training method for a neural network provided in embodiments of the present disclosure.

FIG. 7 is a schematic diagram of an action supervision box for water drinking provided in embodiments of the present disclosure.

FIG. 8 is a schematic diagram of an action supervision box for calling provided in embodiments of the present disclosure.

FIG. 9 is a schematic structural diagram of an action recognition apparatus provided in embodiments of the present disclosure.

FIG. 10 is a schematic structural diagram of a training assembly for a neural network provided in embodiments of the present disclosure.

FIG. 11 is a schematic structural diagram of a driving action analysis apparatus provided in embodiments of the present disclosure.

FIG. 12 is a schematic structural diagram of hardware of an electronic device provided in embodiments of the present disclosure.

### DETAILED DESCRIPTION

Embodiments of the present disclosure are described below with reference to the accompanying drawings in the embodiments of the present disclosure.

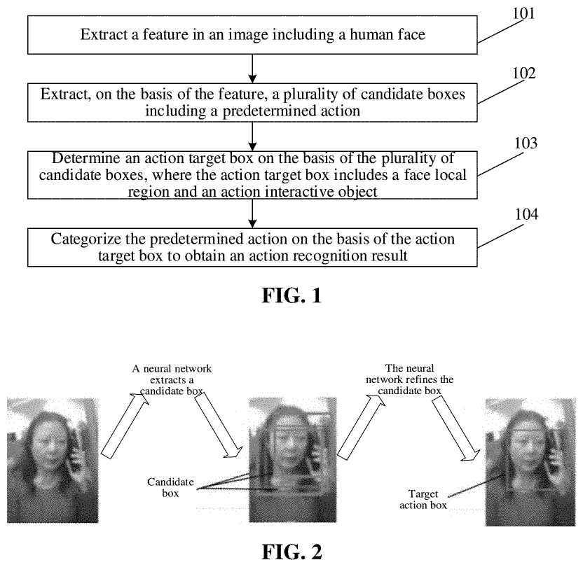

FIG. 1 is a schematic flowchart of an action recognition method provided in embodiments of the present disclosure. As shown in FIG. 1, the method includes the following steps.

At block 101, a feature in an image including a human face is extracted.

The embodiments of the present disclosure mainly perform recognition on an action of a person in a vehicle. Taking a driver as an example, the embodiments of the present disclosure can perform recognition on some driving actions performed by a driver of a vehicle during driving the vehicle, and can provide a prompt for the driver according to the recognition result. During implementing the embodiments of the present disclosure, the inventor finds out that the recognition of some face-related fine actions of the person in the vehicle, such as a water drinking action or a calling action of the driver, is difficult or even cannot be implemented by detection of human body key points or estimation of human body postures. The embodiments of the present disclosure perform feature extraction on an image to be processed and implement recognition of an action in the image to be processed according to an extracted feature. The foregoing action may be: an action of a hand region and/or an action of a face local region, an action for an action interactive object, etc. Therefore, a vehicle-mounted camera is required to perform image acquisition on the person in the vehicle to obtain the image to be processed including a human face. Then a convolutional operation is performed on the image to be processed to extract a feature of the action.

In an optional embodiment of the present disclosure, the method further includes: capturing an image of a person in a vehicle by a vehicle-mounted camera, where the image includes a human face. The person in the vehicle includes at least one of: a driver at a driving region of the vehicle, a person at a front passenger seat region of the vehicle, or a person at a rear seat of the vehicle.

The vehicle-mounted camera may be: a Red-Green-Blue (RGB) camera, an infrared camera, or a near-infrared camera.

At block 102, a plurality of candidate boxes including a predetermined action is determined on the basis of the feature.

The embodiments of the present disclosure mainly perform recognition on a predetermined action of the person in the vehicle. Taking the person in the vehicle being a driver as an example, the predetermined action, for example, may be a predetermined action corresponding to dangerous driving of the driver, or a predetermined action for some dangerous actions of the driver. In an optional implementation, a feature of the predetermined action is first defined, and then the determination of whether the predetermined action is present in the image is implemented by a neural network according to the defined feature and the extracted feature in the image. In the case that it is determined that the predetermined action is present in the image, a plurality of candidate boxes including the predetermined action in the image is determined.

The neural network in the embodiments is well-trained. That is, the feature of the predetermined action in the image can be extracted by the neural network. In an optional embodiment of the present disclosure, the neural network may be configured with a plurality of convolution layers. Richer information in the image can be extracted by the plurality of convolution layers, thereby improving the determination accuracy rate of the predetermined action.

In the embodiments, if the extracted feature corresponds to at least one of the hand region, the face local region, a region corresponding to the action interactive object, or the like, feature regions including the hand region and the face local region are obtained by feature extraction processing of the neural network. Candidate regions are determined on the basis of the feature regions, and the candidate regions are identified by candidate boxes, where the candidate boxes, for example, may be represented by rectangular boxes. Similarly, a feature region including the hand region, the face local region, and the region corresponding to the action interactive object is identified by another candidate box. In this way, the plurality of candidate regions are obtained by extracting the feature corresponding to the predetermined action, and the plurality of candidate boxes are determined according to the plurality of candidate regions.

At block 103, an action target box is determined on the basis of the plurality of candidate boxes, where the action target box includes a face local region and an action interactive object.

The actions recognized in the embodiments of the present disclosure are all human face-related fine actions which are difficult to or even cannot be implemented by detection of human body key points. Moreover, the regions corresponding to these fine actions at least include the face local region and the region corresponding to the action interactive object, for example, including the face local region and the region corresponding to the action interactive object, including the face local region, the region corresponding to the action interactive object, and the hand region, or the like. Therefore, the recognition of these fine actions can be implemented by recognizing a feature in the action target box obtained from the plurality of candidate boxes.

In an optional embodiment of the present disclosure, the face local region includes at least one of: a mouth region, an ear region, or an eye region. The action interactive object includes at least one of: a container, a cigarette, a mobile phone, food, a tool, a beverage bottle, glasses, or a mask.

In an optional embodiment of the present disclosure, the action target box further includes a hand region.

For example, the target action box shown in FIG. 2 includes: a local face, a mobile phone (i.e., an action interactive object), and a hand. For another example, for a smoking action, the target action box may also include: a mouth and a cigarette (i.e., an action interactive object).

In the embodiments, since the candidate box may include feature other than the feature corresponding to the predetermined action, or does not include all features corresponding to the predetermined action (referring to all the features of any predetermined action), the final action recognition result would be affected. Therefore, in order to ensure the precision of the final recognition result, the positions of the candidate boxes need to be adjusted. That is, the action target box is determined on the basis of the plurality of candidate boxes. A deviation may exist between the position and size of the action target box and the positions and sizes of at least some of the plurality of candidate boxes. As shown in FIG. 2, position offsets and scaling factors of corresponding candidate boxes can be determined according to the positions and sizes of the features corresponding to the predetermined action, and then the positions and sizes of the candidate boxes are adjusted according to the position offsets and the sale factors such that the adjusted action target box merely includes the features corresponding to the predetermined action, i.e., all the features corresponding to the predetermined action. On this basis, through the adjustment to the position and size of each candidate box, the adjusted candidate box is determined as the action target box. It can be understood that the plurality of adjusted candidate boxes can be overlapped to form one candidate box, and then the overlapped candidate box is determined as the action target box.

At block 104, the predetermined action is categorized on the basis of the action target box to obtain an action recognition result.

In an optional embodiment of the present disclosure, the predetermined action includes at least one of: calling, smoking, drinking water/beverages, eating food, using a tool, putting on glasses, or doing makeup.

In the embodiments, the predetermined action can be categorized on the basis of the feature corresponding to the predetermined action included in the action target box. As an implementation, a neural network for action categorization can be used to perform categorization processing on the feature corresponding to the predetermined action included in the action target box to obtain a categorization recognition result of the predetermined action corresponding to the feature.

By using the action recognition method of the embodiments of the present disclosure, a feature in an image including a human face is extracted, a plurality of candidate boxes including a predetermined action are determined on the basis of the extracted feature, an action target box is then determined on the basis of the plurality of candidate boxes, and the predetermined action is categorized on the basis of the action target box. Because the action target box of the embodiments of the present disclosure includes a face local region and an action interactive object, during the process of categorizing the predetermined action on the basis of the action target box, an action corresponding to the face local region and the action interactive object is taken as a whole, without splitting a human body part and the action interactive object, and categorization is performed on the basis of the feature corresponding to the whole. Therefore, the recognition of a refined action, especially the recognition of a refined action of a human face region or near the human face region, can be implemented, thereby improving the accuracy and precision of action recognition.

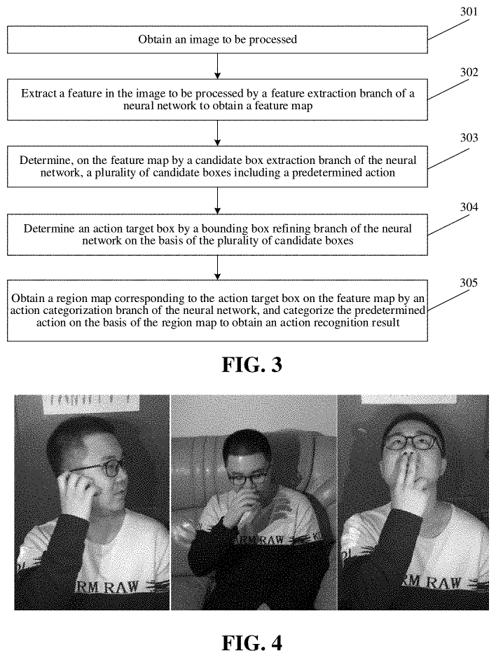

FIG. 3 is a schematic flowchart of another action recognition method provided in embodiments of the present disclosure. As shown in FIG. 3, the method includes the following steps.

At block 301, an image to be processed is obtained, where the image to be processed includes a human face.

In an optional embodiment of the present disclosure, obtaining the image to be processed may include: obtaining the image to be processed by photographing a person in a vehicle by a vehicle-mounted camera, or capturing a video of the person in the vehicle by the vehicle-mounted camera and taking a frame image of the captured video as the image to be processed. The person in the vehicle includes at least one of: a driver at a driving region of the vehicle, a person at a front passenger seat region of the vehicle, or a person at a rear seat of the vehicle. The vehicle-mounted camera may be: an RGB camera, an infrared camera, or a near-infrared camera.

The RGB camera provides three basic color components by three different cables. This type of camera generally obtains three color signals using three independent Charge Coupled Device (CCD) sensors. The RGB camera is frequently used for performing very precise color image acquisition.

Light in the vehicle is more complex than that of the real environment. Moreover, light intensity would directly affect the quality of photographing. In particular, if the light intensity in the vehicle is low, a common camera cannot acquire a clear image or video, resulting in the loss of a part of useful information of the image or video, so as to affect subsequent processing. However, an infrared camera can emit infrared light to a photographed object and then performs imaging according to reflected infrared light, and thus can resolve the problem that a common camera captures an image with low quality or cannot perform normal photographing under a dim or dark condition. On this basis, in the embodiments, a common camera or an infrared camera may be configured. In this case that the light intensity is greater than a preset value, the common camera is used to obtain the image to be processed; and in the case that the light intensity is lower than the preset value, the infrared camera is used to obtain the image to be processed.

At block 302, a feature extraction branch of a neural network extracts a feature in the image to be processed to obtain a feature map.

In an optional embodiment of the present disclosure, the feature extraction branch of the neural network performs a convolutional operation on the image to be processed to obtain a feature map.

In one example, performing the convolutional operation on the image to be processed by the feature extraction branch of the neural network is “sliding” on the image to be processed using a convolution kernel. For example, when the convolution kernel corresponds to a given pixel point of the image, the grayscale value of the pixel point is multiplied by values on the convolution kernel, and the sum of all the products is taken as the grayscale value of the pixel point corresponding to the convolution kernel. The convolution kernel is further “slided” to the next pixel point, and so forth, until the convolutional processing on all the pixel points in the image to be processed is finally completed to obtain the feature map.

It should be understood that the feature extraction branch of the neural network of the embodiments may include a plurality of convolution layers. The feature map of a previous convolution layer obtained by feature extraction can be taken as input data of a next convolution layer. Richer information in the image can be extracted by the plurality of convolution layers, thereby improving the accuracy of feature extraction. By performing stage-by-stage convolutional operations on the image to be processed by the feature extraction branch of the neural network including the plurality of convolution layers, the feature map corresponding to the image to be processed can be obtained.

At block 303, a plurality of candidate boxes including a predetermined action is determined on the feature map by a candidate box extraction branch of the neural network.

In the embodiments, the candidate box extraction branch of the neural network processes the feature map to determine the plurality of candidate boxes including the predetermined action. For example, the feature map may include at least one of features corresponding to a hand, a cigarette, a water cup, a mobile phone, glasses, a mask, and a face local region. The plurality of candidate boxes are determined on the basis of the at least one feature. It should be noted that at step 302, although the feature extraction branch of the neural network can extract the feature of the image to be processed, the extracted feature may include other features other than the feature corresponding to the predetermined action. Therefore, in the plurality of candidate boxes here determined by the candidate box extraction branch of the neural network, at least some of the candidate boxes may include other features other than the feature corresponding to the predetermined action, or do not include all the features corresponding to the predetermined action. Therefore, the plurality of candidate boxes may include the predetermined action.

It should be understood that the candidate box extraction branch of the neural network of the embodiments may include a plurality of convolution layers. The feature extracted by a previous convolution layer is taken as input data of a next convolution layer. Richer information is extracted by the plurality of convolution layers, thereby improving the accuracy of feature extraction.

In an optional embodiment of the present disclosure, determining, on the feature map by the candidate box extraction branch of the neural network, the plurality of candidate boxes including the predetermined action include: dividing features in the feature map according to the feature of the predetermined action to obtain a plurality of candidate regions; and obtaining, according to the plurality of candidate regions, the plurality of candidate boxes and a first confidence of each of the plurality of candidate boxes, where the first confidence is a probability that the candidate box is the action target box.

In the embodiments, the candidate box extraction branch of the neural network recognizes the feature map, divides from the feature map the feature of the hand and the feature corresponding to the face local region, or the feature of the hand, the feature corresponding to the action interactive object (for example, a feature corresponding to a mobile phone), and the feature corresponding to the face local region included in the feature map, determines the candidate regions on the basis of the divided features, and identifies the candidate regions by the candidate boxes (the candidate boxes are, for example, rectangular boxes),In this way, the plurality of candidate regions identified by the candidate boxes are obtained.

In the embodiments, the candidate box extraction branch of the neural network can further determine the first confidence corresponding to each candidate box, where the first confidence is used for representing, in the form of probability, the possibility that the candidate box is the target action box. By the processing of the candidate box extraction branch of the neural network on the feature map, the first confidence of each of the plurality of candidate boxes is obtained while obtaining the plurality of candidate boxes. It should be understood that the first confidence is a predicated value, obtained by the candidate box extraction branch of the neural network according to the feature in the candidate box, that the candidate box is the target action box.

At block 304, an action target box is determined by a bounding box refining branch of the neural network on the basis of the plurality of candidate boxes, where the action target box includes a face local region and an action interactive object.

In an optional embodiment of the present disclosure, determining the action target box by the bounding box refining branch of the neural network on the basis of the plurality of candidate boxes includes: removing, by the bounding box refining branch of the neural network, the candidate box having the first confidence smaller than a first threshold to obtain at least one first candidate box; performing pooling processing on the at least one first candidate box to obtain at least one second candidate box; and determining the action target box according to the at least one second candidate box.

In the embodiments, during the process of obtaining the candidate boxes, some actions similar to the predetermined action would bring large interference on the candidate box extraction branch of the neural network. In sub-images from left to right in FIG. 4, a target object performs the actions of calling, drinking water, smoking, etc., in sequence. These actions are similar, i.e., all relating to respectively putting the right hand near the face. However, the target object does not hold a mobile phone, a water cup, or a cigarette in hand. The neural network would is prone to incorrectly recognize these actions of the target object as calling, drinking water, and smoking. Moreover, in the case that the predetermined action is a predetermined dangerous driving action, during the process of driving the vehicle, the driver may perform, for example, the action of scratching an ear due to itching in an ear region, or the action of opening mouth or putting a hand on lips due to other reasons. It is obvious that these actions are not predetermined dangerous driving actions. However, these actions would bring large interference to the candidate box extraction branch of the neural network during a candidate box extraction process, thereby affecting the subsequent categorization of the actions and causing the obtaining of an incorrect action recognition result.

The embodiments of the present disclosure remove, by the bounding box refining branch of the pre-trained neural network, the candidate box having the first confidence smaller than the first threshold to obtain at least one first candidate box, where the first confidence of the at least one first candidate box is greater than or equal to the first threshold. If the first confidence of the candidate box is smaller than a first threshold, it indicates that the candidate box is a candidate box of an action similar to the above actions, and the candidate box needs to be removed, such that the predetermined action can be efficiently distinguished from the similar action, thereby reducing a false detection rate and greatly improving the accuracy of the action recognition result. The first threshold, for example, may be 0.5. Certainly, the value of the first threshold in the embodiments of the present disclosure is not limited thereto.

In an optional embodiment of the present disclosure, performing pooling processing on the at least one first candidate box to obtain the at least one second candidate box includes: performing pooling processing on the at least one first candidate box to obtain at least one first feature region corresponding to the at least one first candidate box; and adjusting the position and size of a corresponding first candidate box on the basis of each first feature region to obtain the at least one second candidate box.

In the embodiments, there may be a plurality of features in the region where the first candidate box is located. If the features in the region where the first candidate box is located are directly used, great amount of computation would be caused. Therefore, before performing subsequent processing on the features in the region where the first candidate box is located, pooling processing is first performed on the first candidate box. That is, pooling processing is performed on the features in the region where the first candidate box is located to lower the dimension of the features in the region where the first candidate box is located, so as to satisfy the requirements on the amount of computation during the subsequent processing, thereby greatly reducing the amount of the computation of the subsequent processing. Similar to the obtaining of the candidate regions at step 303, the feature on which pooling processing is performed is divided according to the feature of the predetermined action to obtain the plurality of first features regions. It can be understood that the embodiments present the feature, in the first feature region, corresponding to the predetermined action in a low dimension by performing pooling processing on the region corresponding to the first candidate box.

As an example, the specific implementation process of pooling processing may be shown in the following example: it is assumed that the size of the first candidate is represented as h*w, where h may represent the height of the first candidate box and w may represent the width of the first candidate box; if the target size of a feature that is expected to be obtained is H*W, the first candidate box can be divided into H*W grids, where the size of each grid may be represented as (h/H)*(w/W); then an average grayscale value of pixel points in each grid is calculated or the maximum grayscale value in each grid is determined; and the average grayscale value or the maximum grayscale value is taken as a value corresponding to each grid, so as to obtain a pooling processing result of the first candidate box.

In an optional embodiment of the present disclosure, adjusting the position and size of the corresponding first candidate box on the basis of each first feature region to obtain the at least one second candidate box includes: obtaining, on the basis of a feature corresponding to the predetermined action in the first feature region, a first action feature box corresponding to the feature of the predetermined action; obtaining a first position offset of the at least one first candidate box according to coordinates of a geometric center of the first action feature box; obtaining a first scaling factor of the at least one first candidate box according to the size of the first action feature box; and respectively adjusting the position and size of the at least one first candidate box on the basis of at least one first position offset and at least one first scaling factor to obtain the at least one second candidate box.

In the embodiments, in order to facilitate subsequent processing, the feature in the first feature region corresponding to each predetermined action is respectively identified by the first action feature box. The first action feature box may specifically be a rectangular box. For example, the feature in the first feature region corresponding to each predetermined action is identified by a rectangular box.

In the embodiments, coordinates of the geometric center of the first action feature box in a pre-established XOY coordinate system are obtained, and the first position offset of the first candidate box corresponding to the first action feature box is determined according to the coordinates of the geometric center, where the XOY coordinate system is generally a coordinate system with O set as an origin, the horizontal direction as an X-axis, and the direction perpendicular to the X-axis as a Y-axis. Since the first action feature box is determined from the first feature region on the basis of the feature of the predetermined action and the first feature region is divided and determined from the first candidate box on the basis of the feature of the predetermined action, a deviation generally exists between the geometric center of the first action feature box and the geometric center of the first candidate box, and the first position offset of the first candidate box is determined according to the deviation. As an example, the offset between the geometric center of the first action feature box and the geometric center of the first candidate box corresponding to the feature of the same predetermined action can be taken as the first position offset of the first candidate box.

In the case that there are a plurality of first candidate boxes corresponding to the feature of the same predetermined action, each first candidate box corresponds to a first position offset, where the first position offset includes the position offset in the X-axis direction and the offset in the Y-axis direction. As an example, the XOY coordinate system takes the upper left corner of the first feature region (with the orientation of the candidate box refining branch of the input neural network as a reference) as an origin, the horizontal right direction as the positive direction of the X-axis, and the vertical down direction as the positive direction of the Y-axis. In other examples, the XOY coordinate system may take the lower left corner, the upper right corner, the lower right corner, or the central point of the first feature region as the origin, the horizontal right direction as the positive direction of the X-axis, and the vertical down direction as the positive direction of the Y-axis.

In the embodiments, the size of the first action feature box, specifically the length and width of the first action feature box, is obtained, and the first scaling factor corresponding to the first candidate box is determined according to the length and width of the first action feature box. In an example, the first scaling factor of the first candidate box can be determined on the basis of the length and width of the first action feature box and the length and width of the corresponding first candidate box.

Each first candidate box corresponds to a first scaling factor, and the first scaling factors of different first candidate boxes may the identical or different.

In the embodiments, the position and size of the first candidate box is adjusted according to the first position offset and the first scaling factor corresponding to each first candidate box. As one implementation, a second candidate box is obtained by moving the first candidate box according to the first position offset, and adjusting, according to the first scaling factor, the size of the first candidate box with the geometric center as a center. It should be understood that the number of the second candidate boxes is the same as that of the first candidate boxes. The second candidate box obtained by the method above would include, with the smallest possible size, all the features of the predetermined action, so as to facilitate improving the precision of a subsequent action categorization result.

In the embodiments, for the plurality of second candidate boxes, the second candidate boxes having similar sizes and similar geometric centers are combined as one second candidate box, and the combined second candidate box is taken as the action target box. It should be understood that the second candidate boxes corresponding to the same predetermined action may have very close sizes and distances between geometric centers. Therefore, each predetermined action may correspond to one action target box.

As an example, if a driver is smoking while calling, the obtained image to be processed may include features corresponding to two predetermined actions, i.e., calling and smoking. Through the processing method above, a candidate box including a feature corresponding to the predetermined action of calling can be obtained, where the candidate box includes a hand, a mobile phone, and a face local region, and a candidate box including a feature corresponding to the predetermined action of smoking can also be obtained, where the candidate box includes a hand, a cigarette, and a face local region. Although there may be a plurality of candidate boxes corresponding to the predetermined action of calling and a plurality of candidate boxes corresponding to the predetermined action of smoking, all the candidate boxes corresponding to the predetermined action of calling have similar sizes and distances between geometric centers, and all the candidate boxes corresponding to the predetermined action of smoking have similar sizes and distances between geometric centers. Moreover, the difference between the size of any candidate box corresponding to the predetermined action of calling and the size of any candidate box corresponding to the predetermined action of smoking is greater than the difference between the sizes of any two candidate boxes corresponding to the predetermined action of calling, and is also greater than the difference between the sizes of any two candidate boxes corresponding to the predetermined action of smoking; and the distance between the geometric center of any candidate box corresponding to the predetermined action of calling and the geometric center of any candidate box corresponding to the predetermined action of smoking is greater than the distance between the geometric centers of any two candidate boxes corresponding to the predetermined action of calling, and is also greater than the distance between the geometric centers of any two candidate boxes corresponding to the predetermined action of smoking. All the candidate boxes corresponding to the predetermined action of calling are combined to obtain an action target box, and all the candidate boxes corresponding to the predetermined action of smoking are combined to obtain another action target box. In this way, two action target boxes are respectively obtained corresponding to the two predetermined actions.

At block 305, a region map corresponding to the action target box on the feature map is obtained by an action categorization branch of the neural network, and the predetermined action is categorized on the basis of the region map to obtain the action recognition result.

In the embodiments, the action categorization branch of the neural network divides a region corresponding to the action target box from the feature map to obtain the region map, categorizes the predetermined action on the basis of the feature in the region map to obtain a first action recognition result, and obtains an action recognition result corresponding to the image to be processed according to the first action recognition result corresponding to all target action boxes.

In an optional embodiment of the present disclosure, on one hand, the action categorization branch of the neural network obtains the first action recognition result, and on the other hand, the action categorization branch of the neural network can further obtain a second confidence of the first action recognition result, where the second confidence represents the accuracy of the action recognition result. Obtaining the action recognition result corresponding to the image to be processed according to the first action recognition result corresponding to all target action boxes includes: comparing the second confidence of the first action recognition result corresponding to each target action box with a preset threshold to obtain the first action result having the second confidence greater than the preset threshold; and determining the action recognition result corresponding to the image to be processed according to the first action result having the second confidence greater than the preset threshold.

For example, the vehicle-mounted camera photographs the driver to obtain an image including the face of the driver, and inputs same to the neural network as the image to be processed. If it is assumed that the driver in the image to the processed correspondingly has an action of “calling”, two action recognition results, i.e., the action recognition result of “calling” and the action recognition result of “drinking water”, are obtained by the processing of the neural network, where the second confidence of the action recognition result of “calling” is 0.8, and the second confidence of the action recognition result of “drinking water” is 0.4.If the set preset threshold is 0.6, it can be determined that the action recognition result of the image to be processed is the action of “calling”.

In the embodiments, in the case that the action recognition result is a particular predetermined action, the method may further include: outputting prompt information. The particular predetermined action may be a dangerous driving action, where the dangerous driving action is an action which may cause a dangerous event to a driving process when the driver drives a vehicle. The dangerous driving action may be an action generated by the driver himself/herself, or an action generated by another person in a driving cabin. Outputting the prompt information may be outputting prompt information by at least one of an audio, a video, or text. For example, a terminal can be used to output prompt information to a person in the vehicle (for example, the driver and/or other persons in the vehicle). The mode for outputting the prompt information may be providing a prompt by displaying text by the terminal, providing the prompt by outputting voice data by the terminal, etc. The terminal may be a vehicle-mounted terminal. Optionally, the terminal may be equipped with a display screen and/or an audio output function.

The particular predetermined actions are drinking water, calling, putting on glasses, and the like. If the action recognition result obtained by the neural network is any one or more of the particular predetermined actions, the prompt information is output, and the category of the particular predetermined action (for example, the dangerous driving action) may also be output. In the case that no particular predetermined action is detected, the prompt information may not be output, or the category of the predetermined action may also be output.

As an example, in the case that the obtained action recognition result includes a particular predetermined action (for example, the dangerous driving action), a dialog box can be displayed by a Head Up Display (HUD), to provide prompt information to the driver by displayed content. The prompt information may also be output by a built-in audio output function of the vehicle. For example, audio information such as “would the driver please pay attention to your driving action” can be output. The prompt information may also be output by releasing a gas having a refreshing effect. For example, florida water mist is sprayed out by means of a vehicle-mounted nozzle because the smell of florida water is fragrant and pleasant, and can implement a refreshing effect while providing a prompt to the driver. The prompt information may also be output by stimulating the driver by discharging a low current by a seat, so as to achieve a prompting and alerting effect.

The embodiments of the present disclosure perform feature extraction on an image to be processed by a feature extraction branch of a neural network; obtain, by a candidate box extraction branch of the neural network according to the extracted feature, a candidate box including a predetermined action; determine an action target box by a bounding box refining branch of the neural network; and finally categorize the predetermined action for the feature in the target action box by an action categorization branch of the neural network to obtain an action recognition result of the image to be processed. By extracting and processing the feature in the image to be processed (for example, feature extraction of a hand region, a face local region, and a region corresponding to an action interactive object), the whole recognition process can autonomously and quickly implement the precise recognition of a fine action.

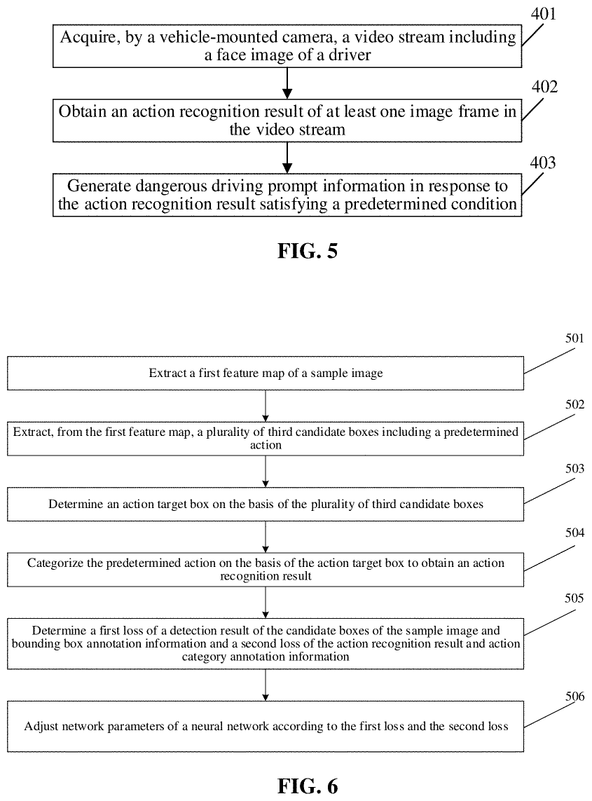

Embodiments of the present disclosure also provide a driving action analysis method. FIG. 5 is a schematic flowchart of a driving action analysis method provided in embodiments of the present disclosure. As shown in FIG. 5, the method includes the following steps.

At block 401, a vehicle-mounted camera acquires a video stream including a face image of a driver.

At block 402, an action recognition result of at least one image frame in the video stream is obtained.

At block 403, dangerous driving prompt information is generated in response to the action recognition result satisfying a predetermined condition.

In the embodiments, the vehicle-mounted camera captures a video of the driver to obtain the video stream, and each frame image of the video stream is taken as an image to be processed. Action recognition is performed on each image frame to obtain a corresponding action recognition result, and a driving state of the driver is recognized according to the action recognition results of a plurality of continuous image frames to determine whether the driving state is a dangerous driving state corresponding to a dangerous driving action. The processing procedures for the action recognition of the plurality of image frames are as stated in the foregoing embodiments, and the details are not described here again.

In an optional embodiment of the present disclosure, the predetermined condition includes at least one of: the occurrence of a particular predetermined action, the number of occurrences of the particular predetermined action within a predetermined duration, or a maintained duration of the occurrence of the particular predetermined action in the video stream.

In the embodiments, the particular predetermined action may be the predetermined action, in the categories of predetermined actions in the foregoing embodiments, corresponding to the dangerous action, for example, corresponding to the water drinking action, calling action, or the like of the driver. Responding to the action recognition result satisfying the predetermined condition may include: in the case that the action recognition result includes the particular predetermined action, determining that the action recognition result satisfies the predetermined condition; or in the case that the action recognition result includes the particular predetermined action and the number of occurrences of the particular predetermined action within a predetermined duration reaches a preset number, determining that the action recognition result satisfies the predetermined condition; or in the case that the action recognition result includes the particular predetermined action and the duration of the occurrence of the particular predetermined action in the video stream reaches a preset duration, determining that the action recognition result satisfies the predetermined condition.

For example, when it is detected that the driver is performing any action of drinking water, calling, and putting on glasses, dangerous driving prompt information can be generated and output by the vehicle-mounted terminal, and the category of the particular predetermined action can also be output. The mode for outputting the dangerous driving prompt information may include: outputting the dangerous driving prompt information by displaying text by the vehicle-mounted terminal and outputting the dangerous driving prompt information by the audio output function of the vehicle-mounted terminal.

In an optional embodiment of the present disclosure, the method further includes: obtaining a speed of a vehicle provided with a vehicle-mounted dual-lens camera; and generating the dangerous driving prompt information in response to the action recognition result satisfying the predetermined condition includes: generating the dangerous driving prompt information in response to the speed being greater than a set threshold and the action recognition result satisfying the predetermined condition.

In the embodiments, in the case that the speed is not greater than the set threshold, the dangerous driving prompt information cannot be generated and output even if the action recognition results satisfies the preset condition. The dangerous driving prompt information is generated and output merely in the case that the speed is greater than the set threshold and the action recognition result satisfies the predetermined condition.

In the embodiments, the vehicle-mounted camera captures a video of the driver to obtain the video stream, and each image frame of the captured video is taken as an image to be processed. A corresponding recognition result is obtained by recognizing each image frame captured by the camera, and the action of the driver is recognized according to the results of a plurality of continuous image frames. When it is detected that the driver is performing any action of drinking water, calling, and putting on glasses, an alarm can be provided to the driver by a display terminal, and the category of the dangerous driving action is prompted. The mode for providing the alarm includes: providing the alarm by text in a pop-up dialog box and providing the alarm by built-in voice data.

A neural network of the embodiments of the present disclosure is obtained by pre-supervised training based on a training image set. The neural network may include network layers such as a convolution layer, a non-linear layer, and a pooling layer. The embodiments of the present disclosure do not limit the specific network structure. After determining the neural network structure, iterative trainings may be performed on the neural network by means of back gradient propagation, etc., under supervision based on sample images with annotation information. The specific training method is not limited in the embodiments of the present disclosure.

FIG. 6 is a schematic flowchart of a training method for a neural network provided in embodiments of the present disclosure. As shown in FIG. 6, the method includes the following steps.

At block 501, a first feature map of a sample image is extracted.

The embodiments can obtain, from a training image set, a sample image for training a neural network, where the training image set includes a plurality of sample images.

In an optional embodiment of the present disclosure, the sample images in the training image set includes: a positive sample image and a negative sample image. The positive sample image includes at least one predetermined action corresponding to the target object, where the predetermined action, for example, is the action of drinking water, smoking, calling, putting on glasses, putting on a mask, or the like of the target object. The negative sample image includes at least one action similar to the predetermined action, for example, the action of putting a hand on lips, scratching an ear, touching the nose, or the like of the target object.

The embodiments take the sample image including the action similar to the predetermined action as the negative sample image, and performs positive sample image and negative sample image distinguishing training on the neural network such that the trained neural network can efficiently distinguish the action similar to the predetermined action, thereby greatly improving the precision and robustness of the action categorization result.

In the embodiments, the first feature map of the sample image can be extracted by a convolution layer in the neural network. The detailed process for extracting the first feature map of the sample image is as described in the forgoing step 302, and the details are not described here again.

At block 502, a plurality of third candidate boxes including a predetermined action is extracted from the first feature map.

The detailed process of this step is as described in the step 303 in the foregoing embodiments, and the details are not described here again.

At 503, an action target box is determined on the basis of the plurality of third candidate boxes.

In an optional embodiment of the present disclosure, determining the action target box on the basis of the plurality of third candidate boxes includes: obtaining a first action supervision box according to the predetermined action, where the first action supervision box includes: a face local region and an action interactive object, or the face local region, a hand region, and the action interactive object; obtaining a second confidence of each of the plurality of third candidate boxes, where the second confidence includes a first probability that the third candidate box is the action target box, and a second probability that the third candidate box is not the action target box; determining an area overlapping degree between areas of the plurality of third candidate boxes and the first action supervision box; if the area overlapping degree is greater than or equal to a second threshold, taking the first probability as the second confidence of the third candidate box corresponding to the area overlapping degree; if the area overlapping degree is smaller than the second threshold, taking the second probability as the second confidence of the third candidate box corresponding to the area overlapping degree; removing the plurality of third candidate boxes having the second confidences smaller than the first threshold to obtain a plurality of fourth candidate boxes; and adjusting the position and size of the fourth candidate box to obtain the action target box.

In the embodiments, regarding recognition of face-related fine actions, a feature of the predetermined action can be defined in advance. For example, the feature of the action of drinking water includes features of the hand region, the face local region, and a water cup region (i.e., the region corresponding to the action interactive object). The feature of the action of smoking includes features of the hand region, the face local region, and a cigarette region (i.e., the region corresponding to the action interactive object). The feature of the action of calling includes features of the hand region, the face local region, and a mobile phone region (i.e., the region corresponding to the action interactive object). The feature of the action of putting on glasses includes features of the hand region, the face local region, and a glasses region (i.e., the region corresponding to the action interactive object). The feature of the action of putting on a mask includes features of the hand region, the face local region, and a mask region (i.e., the region corresponding to the action interactive object).

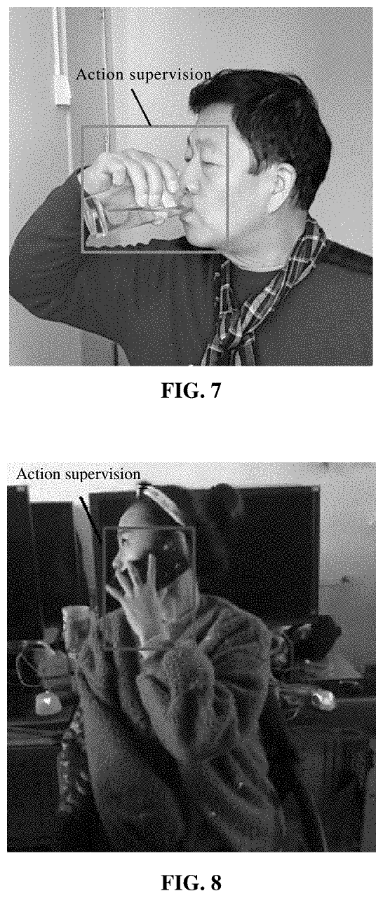

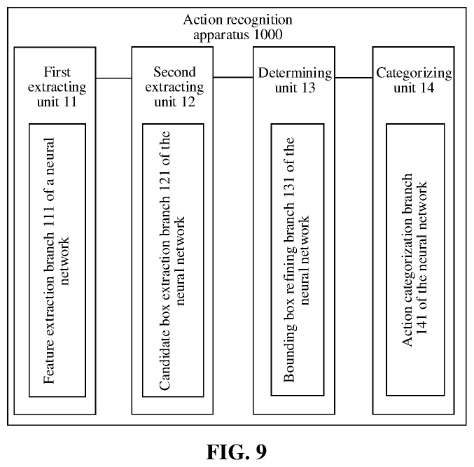

In the embodiments, the annotation information of the sample image includes an action supervision box and an action category corresponding to the action supervision box. It can be understood that the annotation information corresponding to each sample image is further required to be obtained before performing processing on the sample image by the neural network. The action supervision box is specifically used for recognizing the predetermined action in the sample image. For details, refer to the action supervision box for the water drinking action of the target object in FIG. 7 and the action supervision box of the calling action of the target object in FIG. 8.

The action similar to the predetermined action would usually bring large interference on the candidate box extraction process of the neural network. For example, in FIG. 4, actions similar to calling, water drinking, and smoking are sequentially performed from left to right, i.e., the target object respectively puts his right hand near his face. However, in this case, the target object does not hold a mobile phone, a cigarette, or a cigarette in his hand, and the neural network would be prone to incorrectly recognize the actions as calling, water drinking, and smoking, and respectively identifies the candidate boxes corresponding thereto. Therefore, by performing positive sample image and negative sample image distinguishing training on the neural network in the embodiments of the present disclosure, the first action supervision box corresponding to the positive sample image includes the predetermined action, and the first action supervision box corresponding to the negative sample image also includes an action similar to the predetermined action.

In the embodiments, a second confidence corresponding to a third candidate box can further be obtained while identifying the third candidate box by the neural network, where the second confidence includes a probability that the third candidate box is the action target box, i.e., a first probability, and a probability that the third candidate box is not the action target box, i.e., a second probability. In this way, the second confidence of each third candidate box is further obtained while obtaining the plurality of candidate boxes by the neural network. It should be understood that the second confidence is a predicated value, obtained by the neural network according to the feature in the third candidate boxes, that the third candidate box is the target action box. In addition, coordinates (x3, y3) of the third candidate box in a coordinate system XOY and the size of the third coordinate box can further be obtained by the processing of the neural network while obtaining the third candidate box and the second confidence, where the size of the third candidate box can be represented by the product of length and width. The coordinates (x3, y3) of the third candidate box may be coordinates of one vertex of the third candidate box, for example, the coordinates of the vertex of the upper left corner, the upper right corner, the lower left corner or the lower right corner of the third candidate box. Taking the coordinates (x3, y3) of the third candidate box being the coordinates of the vertex of the upper left corner of the third candidate box as an example, the abscissa x4 of the upper right corner and the ordinate y4 of the lower left corner of the third candidate box can be obtained, and the third candidate box can be represented as bbox (x3, y3, x4, y4).Similarly, the first action supervision box can be represented as bbox_gt (x1, y1, x2, y2).

In the embodiments, an area overlapping degree IOU between respective third candidate box set bbox (x3, y3, x4, y4) and the first action supervision box bbox_gt (x1, y1, x2, y2) is determined. Optionally, the calculation formula of the area overlapping degree IOU is as follows:

$$I O U = \frac{A ⋂ B}{A ⋃ B} \qquad ( 1 )$$

where A and B respectively represent the area of the third candidate box and the area of the first action supervision box, A109 B represents the area of the an overlapping region between the third candidate box and the first action supervision box, and A∪B represents the area of all regions included in the third candidate box and the first action supervision box.

If the area overlapping degree IOU is greater than or equal to the second threshold, it is determined that the third candidate box is a candidate box including the predetermined action, and the first probability is taken as the second confidence box of the third candidate box. If the area overlapping degree IOU is smaller than the second threshold, it is determined that the third candidate box is a candidate box that may not include the predetermined action, and the second probability is taken as the second confidence box of the third candidate box. The value of the second threshold is greater than or equal to 0 and smaller than or equal to 1. The specific value of the second threshold can be determined according to a network training effect.

In the embodiments, the plurality of third candidate boxes having the second confidences smaller than the first threshold can be removed to obtain a plurality of fourth candidate boxes, and the position and size of the fourth candidate box are adjusted to obtain the action target box. The details of the obtaining mode of the action target box are as described in step 304 in the forgoing embodiments.

Adjusting the position and size of the fourth candidate box to obtain the action target box includes: performing pooling processing on the fourth candidate boxes to obtain second feature regions corresponding to the fourth candidate boxes; adjusting the positions and sizes of the corresponding fourth candidate boxes on the basis of the second feature regions to obtain fifth candidate boxes; and obtaining the action target box on the basis of the fifth candidate boxes. Adjusting the positions and sizes of the corresponding fourth candidate boxes on the basis of the second feature regions to obtain the fifth candidate boxes includes: obtaining, according to features in the second feature regions corresponding to the predetermined action, second action feature boxes corresponding to the features of the predetermined action; obtaining second position offsets of the fourth candidate boxes according to the coordinates of the geometric centers of the second action feature boxes; obtaining second scaling factors of the fourth candidate boxes according to the sizes of the second action feature boxes; and adjusting the positions and sizes of the fourth candidate box according to the second position offsets and the second scaling factors to obtain the fifth candidate boxes.

In the embodiments, the coordinates P(xₙ, yₙ) of the geometric centers of the fourth candidate boxes in the coordinate system xoy and the coordinates Q (x, y) of the geometric centers of the second candidate boxes in the coordinate system xoy are respectively obtained, and the second position offsets between the geometric centers of the fourth candidate boxes and the geometric centers of the second action feature boxes, i.e., Δ(xₙ, yₙ)=P(xₙ, yₙ)−Q(x, y), are obtained, where n is a positive integer and the value of n is the same as the number of the fourth candidate boxes.

Δ(xₙ, yₙ) is the second position offsets of the plurality of fourth candidate boxes.

In the embodiments, the sizes of the fourth candidate boxes and the second action feature boxes are respectively obtained, and the sizes of the fourth candidate boxes are divided by the sizes of the second action features boxes to obtain the second scaling factors ε of the fourth candidate boxes, where the second scaling factors ε include the length scaling factors δ and the width scaling factors rₗ of the fourth candidate boxes.

If it is assumed that the set of the coordinates of the geometric centers of the fourth candidate boxes is represented as R(xₙ¹, yₙ¹), it can be obtained according to the second position offsets Δ(xₙ, yₙ) that the set of the coordinates of the geometric centers of the geometric center position-adjusted fourth candidate boxes is R(xₙ², yₙ²), and then the following formula is obtained:

$$\{ \begin{matrix}{x}_{n}^{2} = {x}_{n} + {x}_{n}^{1} \\ {y}_{n}^{2} = {y}_{n} + {y}_{n}^{1}\end{matrix} \qquad ( 2 )$$

It should be understood that the lengths and widths of the fourth candidate boxes are kept unchanged when adjusting the positions of the geometric centers of the fourth candidate boxes.

After obtaining one or more geometric center position-adjusted fourth candidate boxes, the geometric centers of the fourth candidate boxes are fixed and kept unchanged, and the lengths of the fourth candidate boxes are adjusted to δ times and the widths thereof are adjusted to rₗ times according to the second scaling factors ε to obtain the fifth candidate boxes.

In the embodiments, obtaining the action target box according to the fifth candidate boxes includes: combining the plurality of fifth candidate boxes having similar sizes and distances, and taking the combined fifth candidate box as the action target box. It should be understood that the fifth candidate boxes corresponding to the same predetermined action would have very close sizes and distances. Therefore, after the combination, each action target box merely corresponds to one predetermined action.

In an optional embodiment of the present disclosure, a third confidence of the action target box would also be obtained while obtaining the action target box by the processing of the neural network, where the third confidence represents the probability that the action in the action target box is a predetermined action category, i.e., a third probability. For example, the predetermined action may include five categories, i.e., drinking water, smoking, calling, putting on glasses, and putting on a mask. Therefore, the third probability of each action target box includes five probability values, which are respectively probability a that the action in the action target box is a water drinking action, probability b that the action in the action target box is a smoking action, probability c that the action in the action target box is a calling action, probability d that the action in the action target box is a glasses wearing action, and probability e that the action in the action target box is a mask wearing action.

At block 504, the predetermined action is categorized on the basis of the action target box to obtain an action recognition result.

In the embodiments, taking the predetermined action included in the action target box including five categories, i.e., drinking water, smoking, calling, putting on glasses, and putting on a mask, as an example, if it is assumed that the third confidence of the action target box is respectively a=0.65, b=0.45, c=0.7, d=0.45, and e=0.88, the action recognition result can be the mask wearing action. Therefore, in the embodiments, in the third confidences (i.e., the third probabilities) of the action target boxes corresponding to different predetermined actions, the category of the predetermined action having the maximum third confidence (i.e., the third probability) can be selected as the action recognition result. The maximum third confidence (i.e., the third probability) can be recorded as a fourth probability.

At block 505, a first loss of a detection result of the candidate boxes of the sample image and bounding box annotation information and a second loss of the action recognition result and action category annotation information are determined.

At block 506, network parameters of the neural network are adjusted according to the first loss and the second loss.

In the embodiments, the neural network may include the feature extraction branch of the neural network, the candidate box extraction branch of the neural network, the bounding box refining branch of the neural network, and the action categorization branch of the neural network. For the details of the functions of the branches of the neural network, refer to the detailed descriptions of steps 301 to 305 in the foregoing embodiments.

In the embodiments, the network parameters of the neural network are updated by calculating a candidate box coordinate regression loss function smoothₜ₁ and a category loss function soft max

Optionally, the expression of a candidate box extraction loss function (Region Proposal Loss) is as follows:

$$Region Proposal Loss = \frac{1}{N} ( {\sum }_{i} {L}_{softmax} ( {p}_{i} ) + α {\sum }_{i} {smooth}_{l 1} ( {bbox}_{i} - {bbox\_gt}_{j} ) ) \qquad ( 3 )$$

where both N and a are weight parameters of the candidate box extraction branch of the neural network, and Pⁱ is a supervision variable.

The specific expressions of the category loss function soft max and the candidate box coordinate regression loss function smoothₜ₁ are as follows:

$$\begin{matrix}{L}_{softmax} = - \frac{1}{N} {\sum }_{i = 1}^{N} log ( {p}_{i} ) \\ and & ( 4 ) \\ {smooth}_{l 1} ( x ) = \{ \begin{matrix}0.5 {x}^{2} , & \vert x \vert < 1 \\ \vert x \vert - 0.5 , & \vert x \vert = 1\end{matrix} \\ where x = \vert {x}_{1} - {x}_{3} \vert + \vert {y}_{1} - {y}_{3} \vert + \vert {x}_{2} - {x}_{4} \vert + \vert {y}_{2} - {y}_{4} \vert . & ( 5 )\end{matrix}$$

The bounding box refining branch of the neural network updates a weight parameter of a network by a loss function, and the specific expression of the loss function (Bbox Refine Loss) is as follows:

$$Bbox Refine Loss = \frac{1}{M} ( {\sum }_{i} {L}_{softmax} ( {p}_{i} ) + β {\sum }_{i} {smooth}_{l 1} ( {bbox}_{i} - {bbox\_gt}_{j} ) ) \qquad ( 6 )$$

where M is the number of sixth candidate boxes, β is a weight parameter of the bounding box refining branch of the neural network, Pⁱ is a supervision variable, the expressions of the soft max loss function and the smoothₜ₁ loss function are shown in formula (4) and formula (5), bboxᵢ in the formula (6) is specifically the coordinates of the geometric center of the refined action target box, and bbox_gtⱼ is the coordinates of the geometric center of the action supervision action box.

In the embodiments, the loss function is a target function for neural network optimization. The process for neural network training or neural network optimization is the process for minimizing the loss function. That is, the closer the value of the loss function is to 0, the closer the value of the corresponding predicted result is to the value of a real result.

In the embodiments, the supervision variable pᵢ in formula (3) and formula (4) is replaced with the second confidence of the fourth candidate box, and the second confidence is substituted into formula (3). The value of the Region Proposal Loss (i.e., the first loss) is changed by adjusting the weight parameters N and α of the candidate box extraction branch of the neural network, and the weight parameter combination N and α which make the value of the Region Proposal Loss closest to 0 is selected.

In the embodiments, the supervision variable Pᵢ in formula (6) is replaced with the fourth probability (i.e., the maximum one of the plurality of third confidences (i.e., the third probability)) of the action target box, the value of the Bbox Refine Loss (i.e., the second loss) is changed by adjusting the weight parameter β of the bounding box refining branch of the neural network, and the weight parameter β which makes the value of the Bbox Refine Loss closest to 0 is selected, so as to complete the update of the weight parameter of the bounding box refining branch of the neural network in the mode of back gradient propagation.

The weight parameter-updated candidate box extraction branch, the weight parameter-updated bounding box refining branch, the feature extraction branch, and the action categorization branch are trained again. That is, the sample image is input to and processed by the neural network, and the recognition result is finally output by the action categorization branch of the neural network. Since an error exists between the output result of the action categorization branch and an actual result, an error between an output value of the action categorization branch and an actual value is back-propagated from an output layer to convolution layers until it is propagated to an input layer. During the process of back propagation, the weight parameters in the neural network are adjusted according to the error, and the process is continuously iterated until it is converged to complete another update of the network parameters of the neural network.

In the embodiments, a face fine action of the person in the vehicle, for example, a hand-related or face-related dangerous driving action of the driver, is recognized according to the feature of the action. However, during actual applications, some actions similar to a dangerous driving action performed by the driver would easily interfere on the neural network and affect subsequent action categorization recognition. This would not only reduce the precision of the action recognition result, but also significantly decrease user experience. The embodiments take a positive sample image and a negative sample image as sample images for training the neural network, perform supervision using a loss function, update the network parameters of the neural network (especially the weight parameters of the feature extraction branch of the neural network and the candidate box extraction branch of the neural network) in the mode of back gradient propagation, and complete the training, such that the feature extraction branch of the trained neural network can accurately extract the feature of the dangerous driving action, and the candidate box extraction branch of the neural network automatically removes the candidate box including the action similar to the predetermined action (for example, the dangerous driving action), thereby greatly reducing the false detection rate of the dangerous driving action.

In addition, since the action candidate box output by the candidate box extraction branch of the neural network has a relatively large size, if the subsequent processing is directly performed on the action candidate box, large computation amount would be caused. In the embodiments, by performing pooling processing on the candidate box and adjusting same to a predetermined size, the computation amount of subsequent processing can be greatly reduced to quicken the processing speed; and by performing refining on the candidate box by the bounding box refining branch of the neural network, the refined action target box merely includes the feature of the predetermined action (for example, the dangerous driving action), such that the accuracy of the recognition result is improved.

Referring to FIG. 9, FIG. 9 is a schematic structural diagram of an action recognition apparatus provided in embodiments of the present disclosure. The recognition apparatus 1000 includes: a first extracting unit 11, a second extracting unit 12, a determining unit 13, and a categorizing unit 14.

The first extracting unit 11 is configured to extract a feature in an image including a human face;

the second extracting unit 12 is configured to determine, on the basis of the feature, a plurality of candidate boxes including a predetermined action;

the determining unit 13 is configured to determine an action target box on the basis of the plurality of candidate boxes, where the action target box includes a face local region and an action interactive object; and

the categorizing unit 14 is configured to categorize the predetermined action on the basis of the action target box to obtain an action recognition result.

In an optional embodiment of the present disclosure, the face local region includes at least one of: a mouth region, an ear region, or an eye region.

In an optional embodiment of the present disclosure, the action interactive object includes at least one of: a container, a cigarette, a mobile phone, food, a tool, a beverage bottle, glasses, or a mask.

In an optional embodiment of the present disclosure, the action target box further includes a hand region.

In an optional embodiment of the present disclosure, the predetermined action includes at least one of: calling, smoking, drinking water/beverages, eating food, using a tool, putting on glasses, or doing makeup.

In an optional embodiment of the present disclosure, the action recognition apparatus 1000 further includes: a vehicle-mounted camera, configured to capture an image of a person in a vehicle, where the image includes the human face.

In an optional embodiment of the present disclosure, the person in the vehicle includes at least one of: a driver at a driving region of the vehicle, a person at a front passenger seat region of the vehicle, or a person at a rear seat of the vehicle.

In an optional embodiment of the present disclosure, the vehicle-mounted camera may be: an RGB camera, an infrared camera, or a near-infrared camera.

The embodiments of the present disclosure perform feature extraction on an image to be processed and implement recognition of an action in the image to be processed according to the extracted feature. The actions may be: an action of a hand region and/or an action of a face local region, an action for an action interactive object, etc. Therefore, a vehicle-mounted camera is required to perform image acquisition on the person in the vehicle to obtain an image to be processed including a human face. Then a convolutional operation is performed on the image to be processed to extract a feature of the action.

In an optional implementation, a feature of the predetermined action is first defined. Then the determination of whether the predetermined action is present in the image is implemented by a neural network according to the defined feature and the extracted feature in the image. In the case that it is determined that the predetermined action is present in the image, a plurality of candidate boxes including the predetermined action is determined in the image.

In the embodiments, if the extracted feature corresponds to at least one of a hand region, a face local region, a region corresponding to the action interactive object, or the like, feature regions including the hand region and the face local region are obtained by feature extraction processing of the neural network. Candidate regions are determined on the basis of the feature regions, and the candidate regions are identified by candidate boxes, where the candidate boxes, for example, may be represented by rectangular boxes. Similarly, a feature region including the hand region, the face local region, and the region corresponding to the action interactive object is identified by another candidate box. In this way, the plurality of candidate regions are obtained by extracting the feature corresponding to the predetermined action, and the plurality of candidate boxes are determined according to the plurality of candidate regions.

In the embodiments, since the candidate box may include a feature other than the feature corresponding to the predetermined action, or does not include all features corresponding to the predetermined action (referring to all the features of any predetermined action), the final action recognition result would be affected. Therefore, in order to ensure the precision of the final recognition result, the positions of the candidate boxes need to be adjusted. That is, the action target box is determined on the basis of the plurality of candidate boxes. On this basis, through the adjustment to the position and size of each candidate box, the adjusted candidate box is determined as the action target box. It can be understood that the plurality of adjusted candidate boxes can be overlapped to form one candidate box, and then the overlapped candidate box is determined as the action target box.

In an optional embodiment of the present disclosure, the first extracting unit 11 includes a feature extraction branch 111 of a neural network, configured to extract the feature in the image including the human face to obtain a feature map.

In the embodiments, performing the convolutional operation on the image to be processed by the feature extraction branch of the neural network is “sliding” on the image to be processed using a convolution kernel. For example, when the convolution kernel corresponds to a given pixel point of the image, the grayscale value of the pixel point is multiplied by the values on the convolution kernel, and the sum of all the products is taken as the grayscale value of the pixel point corresponding to the convolution kernel. The convolution kernel is further “slided” to the next pixel point, and so forth, until the convolutional processing on all the pixel points in the image to be processed is finally completed to obtain the feature map.

The feature extraction branch 111 of the neural network may include a plurality of convolution layers. The feature map of a previous convolution layer obtained by feature extraction can be taken as input data of a next convolution layer. Richer information in the image can be extracted by the plurality of convolution layers, thereby improving the accuracy of feature extraction.

In an optional embodiment of the present disclosure, the second extracting unit 12 includes: a candidate box extraction branch 121 of the neural network, configured to extract, on the feature map, the plurality of candidate boxes including the predetermined action.

For example, the feature map may include at least one of features corresponding to a hand, a cigarette, a water cup, a mobile phone, glasses, a mask, and a face local region. The plurality of candidate boxes are determined on the basis of the at least one feature. It should be noted that although the feature extraction branch of the neural network can extract the feature of the image to be processed, the extracted feature may include other features other than the feature corresponding to the predetermined action. Therefore, in the plurality of candidate boxes here determined by the candidate box extraction branch of the neural network, at least some of the candidate boxes may include other features other than the feature corresponding to the predetermined action, or do not include all the features corresponding to the predetermined action. Therefore, the plurality of candidate boxes may include the predetermined action.

In an optional embodiment of the present disclosure, the candidate box extraction branch 121 of the neural network is further configured to: divide features in the feature map according to a feature of the predetermined action to obtain a plurality of candidate regions; and obtain, according to the plurality of candidate regions, a first confidence of each of the plurality of candidate boxes, where the first confidence is a probability that the candidate box is the action target box.

The candidate box extraction branch 121 of the neural network includes: a dividing sub-unit, configured to divide features in the feature map according to a feature of the predetermined action to obtain a plurality of candidate regions; and

a first obtaining sub-unit, configured to obtain, according to the plurality of candidate regions, a first confidence of each of the plurality of candidate boxes, where the first confidence is a probability that the candidate box is the action target box.

In the embodiments, the candidate box extraction branch 121 of the neural network can further determine the first confidence corresponding to each candidate box, where the first confidence is used for representing, in the form of probability, the possibility that the candidate box is the target action box. By the processing of the candidate box extraction branch of the neural network on the feature map, the first confidence of each of the plurality of candidate boxes is obtained while obtaining the plurality of candidate boxes. It should be understood that the first confidence is a predicated value, obtained by the candidate box extraction branch of the neural network according to the feature in the candidate box, that the candidate box is the target action box.

In an optional embodiment of the present disclosure, the determining unit 13 includes: a bounding box refining branch 131 of the neural network, configured to determine the action target box on the basis of the plurality of candidate boxes.

In an optional embodiment of the present disclosure, the bounding box refining branch 131 of the neural network is further configured to: remove the candidate box having the first confidence smaller than a first threshold to obtain at least one first candidate box; perform pooling processing on the at least one first candidate box to obtain at least one second candidate box; and determine the action target box according to the at least one second candidate box.

The bounding box refining branch of the neural network includes: a removing sub-unit, configured to remove the candidate box having the first confidence smaller than a first threshold to obtain at least one first candidate box;

a second obtaining sub-unit, configured to perform pooling processing on the at least one first candidate box to obtain at least one second candidate box; and

a determining sub-unit, configured to determine the action target box according to the at least one second candidate box.

In the embodiments, during obtaining the candidate box, some actions similar to the predetermined action would bring large interference on the candidate box extraction branch of the neural network. In sub-images from left to right in FIG. 4, a target object performs the actions of calling, drinking water, smoking, etc., in sequence. These actions are similar, i.e., all relating to respectively putting the right hand near the face. However, the target object does not hold a mobile phone, a water cup, or a cigarette in hand. The neural network would be prone to incorrectly recognize these actions of the target object as calling, drinking water, and smoking.

The embodiments of the present disclosure remove, by the bounding box refining branch 131 of the neural network, the candidate box having the first confidence smaller than the first threshold to obtain at least one first candidate box, where if the first confidence of the candidate box is smaller than the first threshold, it indicates that the candidate box is a candidate box of a similar action of the above actions, and the candidate box needs to be removed, such that the predetermined action can be efficiently distinguished from the similar action, thereby reducing a false detection rate and greatly improving the accuracy of the action recognition result.

In an optional embodiment of the present disclosure, the bounding box refining branch 131 (or the second obtaining sub-unit) of the neural network is further configured to: respectively perform pooling processing on the at least one first candidate box to obtain at least one first feature region corresponding to the at least one first candidate box; and adjust the position and size of a corresponding first candidate box on the basis of each first feature region to obtain the at least one second candidate box.

In the embodiments, there may be a plurality of features in the region where the first candidate box is located. If the features in the region where the first candidate box is located are directly used, great amount of computation would be caused. Therefore, before performing subsequent processing on the features in the region where the first candidate box is located, pooling processing is first performed on the first candidate box. That is, pooling processing is performed on the features in the region where the first candidate box is located to lower the dimension of the features in the region where the first candidate box is located, so as to satisfy the requirements on the amount of computation during the subsequent processing, thereby greatly reducing the amount of the computation of the subsequent processing.

In an optional embodiment of the present disclosure, the bounding box refining branch 131 (or the second obtaining sub-unit) of the neural network is further configured to: obtain, on the basis of a feature corresponding to the predetermined action in the first feature region, a first action feature box corresponding to the feature of the predetermined action; obtain a first position offset of the at least one first candidate box according to coordinates of a geometric center of the first action feature box; obtain a first scaling factor of the at least one first candidate box according to the size of the first action feature box; and respectively adjust the position and size of the at least one first candidate box on the basis of at least one first position offset and at least one first scaling factor to obtain the at least one second candidate box.

In an optional embodiment of the present disclosure, the categorizing unit 14 includes: an action categorization branch 141 of the neural network, configured to obtain a region map corresponding to the action target box on the feature map, and to categorize the predetermined action on the basis of the region map to obtain the action recognition result.

In an optional embodiment of the present disclosure, on one hand, the action categorization branch 141 of the neural network obtains the first action recognition result, and on the other hand, the action categorization branch 141 of the neural network can further obtain a second confidence of the first action recognition result, where the second confidence represents the accuracy of the action recognition result.

In an optional embodiment of the present disclosure, the neural network is obtained by pre-supervised training based on a training image set, and the training image set includes a plurality of sample images, where annotation information of the sample image includes an action supervision box and an action category corresponding to the action supervision box.

In an optional embodiment of the present disclosure, the training image set includes a positive sample image and a negative sample image, the action of the negative sample image is similar to that of the positive sample image, and the action supervision box of the positive sample includes a face local region and an action interactive object, or the face local region, a hand region, and the action interactive object.

In an optional embodiment of the present disclosure, the action of the positive sample image includes calling, and the negative sample image includes scratching an ear; and/or the positive sample image includes smoking, eating food, or drinking water, and the negative sample image includes the action of opening mouth or putting a hand on lips.

The embodiments of the present disclosure perform feature extraction on the image to be processed by the feature extraction branch 111 of the neural network; obtain, by the candidate box extraction branch 121 of the neural network according to the extracted feature, the candidate box including the predetermined action; determine the action target box by the bounding box refining branch 131 of the neural network; and finally categorize the predetermined action for the feature in the target action box by the action categorization branch 141 of the neural network to obtain the action recognition result of the image to be processed. By extracting and processing the feature in the image to be processed (for example, the feature extraction of the hand region, the face local region, and the region corresponding to the action interactive object), the whole recognition process can autonomously and quickly implement the precise recognition of a fine action.

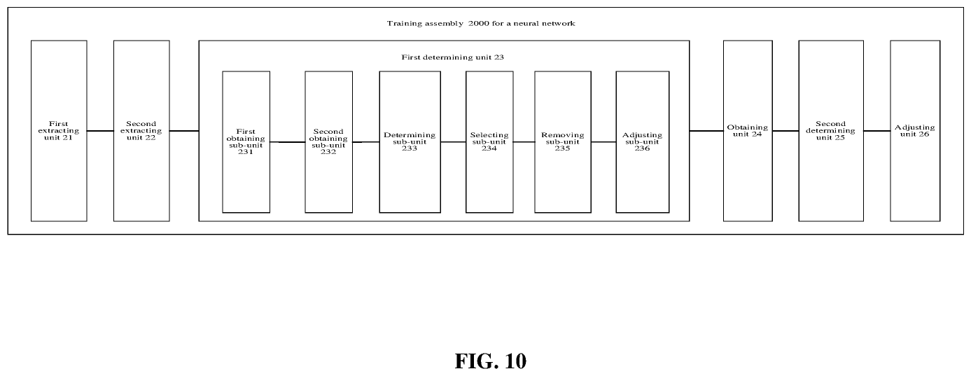

The action recognition apparatus of embodiments of the present disclosure further includes a training assembly for a neural network. Referring to FIG. 10, FIG. 10 is a schematic structural diagram of a training assembly for a neural network provided in embodiments of the present disclosure. The training assembly 2000 includes: a first extracting unit 21, a second extracting unit 22, a first determining unit 23, an obtaining unit 24, a second determining unit 25, and an adjusting unit 26.

The first extracting unit 21 is configured to extract a first feature map of a sample image;

the second extracting unit 22 is configured to extract, from the first feature map, a plurality of third candidate boxes including a predetermined action;

the first determining unit 23 is configured to determine an action target box on the basis of the plurality of third candidate boxes;

the obtaining unit 24 is configured to categorize the predetermined action on the basis of the action target box to obtain an action recognition result;

the second determining unit 25 is configured to determine a first loss of a detection result of the candidate boxes of the sample image and bounding box labeling information and a second loss of the action recognition result and action category labeling information; and

the adjusting unit 26 is configured to adjust network parameters of the neural network according to the first loss and the second loss.

In an optional embodiment of the present disclosure, the first determining unit 23 includes: a first obtaining sub-unit 231, configured to obtain a first action supervision box according to the predetermined action, where the first action supervision box includes: a face local region and an action interactive object, or the face local region, a hand region, and the action interactive object;

a second obtaining sub-unit 232, configured to obtain a second confidence of each of the plurality of third candidate boxes, where the second confidence includes a first probability that fourth candidate box is the action target box, and a second probability that the third candidate box is not the action target box;

a determining sub-unit 233, configured to determine an area overlapping degree between areas of the plurality of third candidate boxes and the first action supervision box;

a selecting sub-unit 234, configured to, if the area overlapping degree is greater than or equal to a second threshold, take the first probability as the second confidence of the third candidate box corresponding to the area overlapping degree, and if the area overlapping degree is less than the second threshold, to take the second probability as the second confidence of the third candidate box corresponding to the area overlapping degree;

a removing sub-unit 235, configured to remove the plurality of third candidate boxes having the second confidences less than the first threshold to obtain a plurality of fourth candidate boxes; and

an adjusting sub-unit 236, configured to adjust the position and size of the fourth candidate box to obtain the action target box.

In the embodiments, a face fine action of the person in the vehicle, for example, a hand-related or face-related dangerous driving action of the driver, is recognized according to the feature of the action. However, during actual applications, some actions similar to a dangerous driving action performed by the driver would easily interfere in the neural network and affect subsequent action categorization recognition. This would not only reduce the precision of the action recognition result, but also significantly decrease user experience. The embodiments take a positive sample image and a negative sample image as sample images for training the neural network, perform supervision using a loss function, update the network parameters of the neural network (especially the weight parameters of the feature extraction branch of the neural network and the candidate box extraction branch of the neural network) in the mode of back gradient propagation, and complete the training, such that the feature extraction branch of the trained neural network can accurately extract the feature of the dangerous driving action, and the candidate box extraction branch of the neural network automatically removes the candidate box including the action similar to the predetermined action (for example, the dangerous driving action), thereby greatly reducing the false detection rate of the dangerous driving action.

In addition, since the action candidate box output by the candidate box extraction branch of the neural network has a relatively large size, if the subsequent processing is directly performed on the action candidate box, large computation amount would be caused. In the embodiments, by performing pooling processing on the candidate box and adjusting same to a predetermined size, the computation amount of subsequent processing can be greatly reduced to quicken the processing speed; and by performing refining on the candidate box by the bounding box refining branch of the neural network, the refined action target box merely includes the feature of the predetermined action (for example, the dangerous driving action), such that the accuracy of the recognition result is improved.

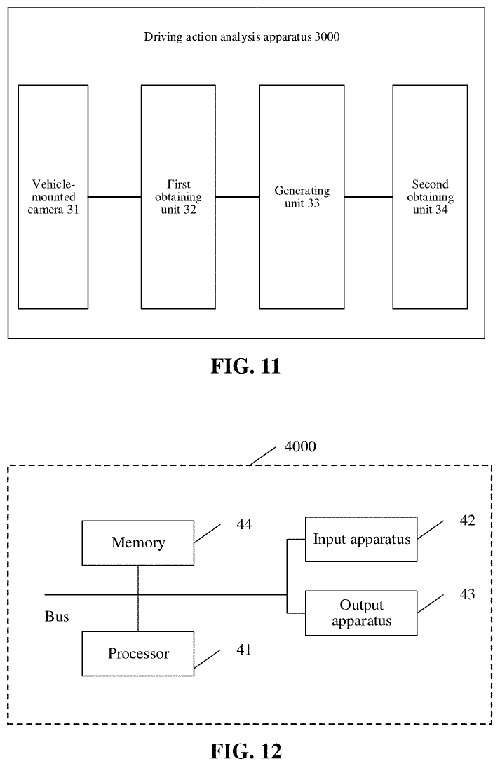

Referring to FIG. 11, FIG. 11 is a schematic structural diagram of a driving action analysis apparatus provided in embodiments of the present disclosure. The analysis apparatus 3000 includes: a vehicle-mounted camera 31, a first obtaining unit 32, and a generating unit 33.

The vehicle-mounted camera 31 is configured to acquire a video stream including a face image of a driver;

the first obtaining unit 32 is configured to obtain an action recognition result of at least one image frame in the video stream by the action recognition apparatus according to the foregoing embodiments of the present disclosure; and

the generating unit 33 is configured to generate distraction prompt information or dangerous driving prompt information in response to the action recognition result satisfying a predetermined condition.

In an optional embodiment of the present disclosure, the predetermined condition includes at least one of: the occurrence of a particular predetermined action, the number of occurrences of the particular predetermined action within a predetermined duration, or a maintained duration of the occurrence of the particular predetermined action in the video stream.

In an optional embodiment of the present disclosure, the analysis apparatus 3000 further includes: a second obtaining unit 34, configured to obtain a speed of a vehicle provided with a vehicle-mounted dual-lens camera; and the generating unit 33 is further configured to: generate the distraction prompt information or dangerous driving prompt information in response to the speed being greater than a set threshold and the action recognition result satisfying the predetermined condition.

In the embodiments, the vehicle-mounted camera captures a video of the driver to obtain the video stream, and each image frame of the captured video is taken as an image to be processed. A corresponding recognition result is obtained by recognizing each image frame captured by the camera, and the action of the driver is recognized according to the results of a plurality of continuous image frames. When it is detected that the driver is performing any action of drinking water, calling, and putting on glasses, an alarm can be provided to the driver by a display terminal, and the category of the dangerous driving action is prompted. The mode for providing the alarm includes: providing the alarm by text in a pop-up dialog box and providing the alarm by built-in voice data.

Embodiments of the present disclosure further provide an electronic device. FIG. 12 is a schematic structural diagram of hardware of an electronic device provided in embodiments of the present disclosure. The electronic device 4000 includes a memory 44 and a processor 41, where the memory 44 stores computer executable instructions thereon, and when the processor 41 runs the computer executable instructions on the memory 44, the action recognition method according to the embodiments of the present disclosure or the driving action analysis method according to the embodiments of the present disclosure is implemented.

In an optional embodiment of the present disclosure, the electronic device further includes an input apparatus 42 and an output apparatus 43.The input apparatus 42, the output apparatus 43, the memory 44, and the processor 41 are interconnected by means of a bus.

The memory includes, but is not limited to, a Random Access Memory (RAM), a Read-Only Memory (ROM), an Erasable Programmable Read Only Memory (EPROM), or a Compact Disc Read-Only Memory (CD-ROM), and is used for related instructions and data.

The input apparatus is configured to input data and/or a signal, and the output apparatus is configured to output data and/or a signal. The output apparatus and the input apparatus may be independent components, or can be an integrated component.

The processor may include one or more processors, for example, including one or more Central Processing Units (CPUs). If the processor is one CPU, the CPU may be a single-core CPU or a multi-core CPU. The processor may further include one or more dedicated processors. The dedicated processors may include GPU, FPGA, and the like, and are used for acceleration processing.

The memory is configured to store program code and data of a network device.

The processor is configured to invoke the program code and the data in the memory to perform the steps in the foregoing method embodiments. For details, refer to the descriptions in the foregoing method embodiments. Details are not described here.

It can be understood that FIG. 12 merely illustrates a simplified design of the electronic device. In actual applications, the electronic device may respectively further includes other necessary elements, including, but not limited to, any number of input/output apparatuses, processors, controllers, memories, etc. moreover, electronic devices that can achieve the embodiments of the present disclosure should all be included within the scope of protection of the present disclosure.

Embodiments of the present disclosure further provide a computer storage medium, configured to store computer readable instructions, where when the instructions are executed, operations of the action recognition method according to any one of the foregoing embodiments of the present disclosure are implemented, or when the instructions are executed, operations of the driving action analysis method according to any one of the foregoing embodiments of the present disclosure are implemented.

Embodiments of the present disclosure further provide a computer program, including computer readable instructions, where when computer readable instructions run in a device, a processor in the device executes executable instructions for implementing the steps in the action recognition method according to any one of the foregoing embodiments of the present disclosure, or a processor in the device executes executable instructions for implementing the steps in the driving action analysis method according to any one of the foregoing embodiments of the present disclosure.

It should be understood that the disclosed device and method in the embodiments provided in the present disclosure may be implemented by means of other modes. The device embodiments described above are merely exemplary. For example, the unit division is merely logical function division and may be actually implemented by other division modes. For example, a plurality of units or components may be combined or integrated into another system, or some features may be ignored or not performed. In addition, the displayed or discussed mutual couplings or direct couplings or communication connections among the components may be implemented by means of some interfaces. The indirect couplings or communication connections between the devices or units may be implemented in electronic, mechanical, or other forms.

The units described as separate components may or may not be physically separate, and the components displayed as units may or may not be physical units, may be located at one position, or may be distributed on a plurality of network units. A part of or all of the units may be selected according to actual needs to achieve the objectives of the solutions of the embodiments.

In addition, the functional units in the embodiments of the present invention may be integrated into one processing unit, or each of the units may exist as an independent unit, or two or more units are integrated into one unit, and the integrated unit may be implemented in the form of hardware, or may also be implemented in the form of a hardware and software functional unit.

A person of ordinary skill in the art may understand that all or some steps for implementing the foregoing method embodiments may be achieved by a program by instructing related hardware. The foregoing program can be stored in a computer readable storage medium. When the program is executed, steps including the foregoing method embodiments are executed. Moreover, the foregoing storage medium includes various media capable of storing program codes, such as a mobile storage device, ROM, RAM, a magnetic disk, or an optical disk.

Or when the aforementioned integrated unit of the present invention is implemented in the form of a software functional unit and sold or used as an independent product, the integrated unit may also be stored in one computer readable storage medium. Based on such an understanding, the technical solutions in the embodiments of the present invention or a part thereof contributing to the prior art may be essentially embodied in the form of a software product. The computer software product is stored in one storage medium and includes several instructions so that one computer device (which may be a personal computer, a server, a network device, and the like) implements all or a part of the method in the embodiments of the present invention. Moreover, the preceding storage medium includes media capable of storing program codes, such as a mobile storage device, the ROM, the RAM, the magnetic disk, or the optical disc.

The methods disclosed in the method embodiments provided by the present disclosure can be arbitrarily combined without causing conflicts so as to obtain a new method embodiment.

The features disclosed in the product embodiments provided by the present disclosure can be arbitrarily combined without causing conflicts so as to obtain a new product embodiment.

The features disclosed in the method or device embodiments provided by the present disclosure can be arbitrarily combined without causing conflicts so as to obtain a new method or device embodiment.

The descriptions above are merely specific implementations of the present invention. However, the scope of protection of the present invention is not limited thereto. Within the technical scope disclosed by the present invention, any variation or substitution that can be easily conceived of by those skilled in the art should all fall within the scope of protection of the present invention. Therefore, the scope of protection of the present invention should be determined by the scope of protection of the appended claims.

1. An action recognition method, comprising:
extracting a feature in an image comprising a human face;
determining, based on the feature, a plurality of candidate boxes comprising a predetermined action;
determining an action target box based on the plurality of candidate boxes, wherein the action target box comprises a face local region and an action interactive object; and
categorizing the predetermined action based on the action target box to obtain an action recognition result.

2. The method according to claim 1, wherein the face local region comprises at least one of: a mouth region, an ear region, or an eye region,
wherein the action interactive object comprises at least one of: a container, a cigarette, a mobile phone, food, a tool, a beverage bottle, glasses, or a mask,
wherein the action target box further comprises a hand region,
wherein the predetermined action comprises at least one of: calling, smoking, drinking water/beverages, eating food, using a tool, putting on glasses, or doing makeup.

3. The method according to claim 1, further comprising:
capturing an image of a person in a vehicle by a vehicle-mounted camera, wherein the image comprises the human face,
wherein the person in the vehicle comprises at least one of: a driver at a driving region of the vehicle, a person at a front passenger seat region of the vehicle, or a person at a rear seat of the vehicle,
wherein the vehicle-mounted camera comprises an RGB camera, an infrared camera, or a near-infrared camera.

4. The method according to claim 1, wherein extracting the feature in the image comprising the human face comprises:
extracting the feature in the image comprising the human face by using a feature extraction branch of a neural network to obtain a feature map.

5. The method according to claim 4, wherein determining, based on the feature, the plurality of candidate boxes comprising the predetermined action comprises:
determining, by using a candidate box extraction branch of the neural network, the plurality of candidate boxes comprising the predetermined action from the feature map, wherein determining, on the feature map by using the candidate box extraction branch of the neural network, the plurality of candidate boxes comprising the predetermined action comprises:
dividing features in the feature map according to a feature corresponding to the predetermined action to obtain a plurality of candidate regions; and
obtaining, according to the plurality of candidate regions, the plurality of candidate boxes and a first confidence of each of the plurality of candidate boxes, wherein the first confidence indicates a probability that the candidate box is the action target box.

6. The method according to claim 4, wherein determining the action target box based on the plurality of candidate boxes comprises:
determining the action target box based on the plurality of candidate boxes by using a bounding box refining branch of the neural network.

7. The method according to claim 6, wherein determining the action target box based on the plurality of candidate boxes by using the bounding box refining branch of the neural network comprises:
removing, by using the bounding box refining branch of the neural network, a candidate box having a first confidence smaller than a first threshold to obtain at least one first candidate box;
performing pooling processing on the at least one first candidate box to obtain at least one second candidate box; and
determining the action target box according to the at least one second candidate box.

8. The method according to claim 7, wherein performing pooling processing on the at least one first candidate box to obtain the at least one second candidate box comprises:
respectively performing pooling processing on the at least one first candidate box to obtain at least one first feature region corresponding to the at least one first candidate box; and
adjusting a position and a size of a respective first candidate box based on each of the at least one first feature region to obtain the at least one second candidate box.

9. The method according to claim 8, wherein adjusting the position and the size of the respective first candidate box based on each of the at least one first feature region to obtain the at least one second candidate box comprises:
obtaining, based on a feature corresponding to the predetermined action in the first feature region, a first action feature box corresponding to the feature of the predetermined action;
obtaining a first position offset of the at least one first candidate box according to geometric center coordinates of the first action feature box;
obtaining at least one first scaling factor of the at least one first candidate box according to the size of the first action feature box; and
respectively adjusting the position and size of the at least one first candidate box based on at least one first position offset and the at least one first scaling factor to obtain the at least one second candidate box.

10. The method according to claim 1, wherein categorizing the predetermined action based on the action target box to obtain the action recognition result comprises:
obtaining a region map corresponding to the action target box from a feature map by using an action categorization branch of a neural network, and
categorizing the predetermined action based on the region map to obtain the action recognition result.

11. The method according to claim 4, wherein the neural network is obtained by pre-supervised training based on a training image set, and the training image set comprises a plurality of sample images,
wherein annotation information of each of the plurality of sample images comprises an action supervision box and an action category corresponding to the action supervision box.

12. The method according to claim 11, wherein the training image set comprises a positive sample image and a negative sample image, the action of the negative sample image is similar to that of the positive sample image, and
wherein an action supervision box of the positive sample image comprises:
a face local region and an action interactive object, or
a face local region, a hand region, and an action interactive object,
wherein the action of the positive sample image comprises calling, and the negative sample image comprises scratching an ear;
the positive sample image comprises smoking, eating food, or drinking water, and the negative sample image comprises opening mouth or putting a hand on lips.

13. The method according to claim 11, wherein the neural network is trained by the following operations:
extracting a first feature map of a sample image;
extracting, from the first feature map, a plurality of third candidate boxes comprising a predetermined action;
determining an action target box based on the plurality of third candidate boxes;
categorizing the predetermined action based on the action target box to obtain an action recognition result;
determining a first loss of a detection result of candidate boxes of the sample image and bounding box annotation information and a second loss of the action recognition result and action category annotation information; and
adjusting network parameters of the neural network according to the first loss and the second loss.

14. The method according to claim 13, wherein determining the action target box based on the plurality of third candidate boxes comprises:
obtaining a first action supervision box according to the predetermined action, wherein the first action supervision box comprises a face local region and an action interactive object, or the face local region, a hand region, and the action interactive object;
obtaining a second confidence of each of the plurality of third candidate boxes, wherein the second confidence comprises a first probability that the third candidate box is the action target box, and a second probability that the third candidate box is not the action target box;
determining an area overlapping degree between areas of the plurality of third candidate boxes and the first action supervision box;
if the area overlapping degree is greater than or equal to a second threshold, taking the first probability as the second confidence of the third candidate box corresponding to the area overlapping degree; or if the area overlapping degree is smaller than the second threshold, taking the second probability as the second confidence of the third candidate box corresponding to the area overlapping degree;
removing the plurality of third candidate boxes having the second confidence smaller than a first threshold to obtain a plurality of fourth candidate boxes; and
adjusting positions and sizes of the plurality of fourth candidate boxes to obtain the action target box.

15. A driving action analysis method, comprising:
acquiring, by using a vehicle-mounted camera, a video stream comprising a face image of a driver;
obtaining an action recognition result of at least one image frame from the video stream through the action recognition method according to claim 1; and
generating dangerous driving prompt information in response to the action recognition result satisfying a predetermined condition.

16. The method according to claim 15, wherein the predetermined condition comprises at least one of: occurrence of a particular predetermined action, a number of times that the particular predetermined action occurs within a predetermined duration, or a maintained duration of the occurrence of the particular predetermined action in the video stream.

17. The method according to claim 15, further comprising:
obtaining a speed of a vehicle provided with a vehicle-mounted dual-lens camera;
wherein generating the dangerous driving prompt information in response to the action recognition result satisfying the predetermined condition comprises: generating the dangerous driving prompt information in response to the speed being greater than a set threshold and the action recognition result satisfying the predetermined condition.

18. An action recognition apparatus, comprising: a processor; and a memory configured to store instructions, wherein the processor is configured to:
extract a feature in an image comprising a human face;
determine, based on the feature, a plurality of candidate boxes comprising a predetermined action;
determine an action target box based on the plurality of candidate boxes, wherein the action target box comprises a face local region and an action interactive object; and
categorize the predetermined action based on the action target box to obtain an action recognition result.

19. A driving action analysis apparatus, a processor; and a memory configured to store instructions, wherein the processor is configured to:
acquire a video stream comprising a face image of a driver;
obtain an action recognition result of at least one image frame in the video stream by the action recognition apparatus according to claim 18; and
generate dangerous driving prompt information in response to the action recognition result satisfying a predetermined condition.

20. A non-transitory computer-readable storage medium having a computer program stored thereon, wherein the computer program, when being executed by a processor, enable the processor to implement the following operations:
extracting a feature in an image comprising a human face;
determining, based on the feature, a plurality of candidate boxes comprising a predetermined action;
determining an action target box based on the plurality of candidate boxes, wherein the action target box comprises a face local region and an action interactive object; and
categorizing the predetermined action based on the action target box to obtain an action recognition result.
